(19) United States
(12) Patent Application Publication
(10) Pub. No.: US 2022/0261388 A1
(43) Pub. Date: Aug. 18, 2022

(54) STORAGE SYSTEM, STORAGE APPARATUS, AND METHOD OF PROCESSING COMPACTION

(71) Applicant: FUJITSU LIMITED, Kawasaki-shi (JP)

(72) Inventor: Shun GOKITA, Kawasaki (JP)

(73) Assignee: FUJITSU LIMITED, Kawasaki-shi (JP)

(21) Appl. No.: 17/533,321

(22) Filed: Nov. 23, 2021

(30) Foreign Application Priority Data
Feb. 15, 2021 (JP) 2021-021785

(51) Int. Cl. G06F 16/22; G06F 16/23; G06F 16/27

(52) U.S. Cl. CPC G06F 16/2272; G06F 16/27; G06F 16/2379

(57) ABSTRACT

A method of processing compaction in a storage system is performed by a storage apparatus and an information processing apparatus. The storage apparatus divides a sorted index structure at a predetermined position into a first and a second portion, performs the compaction on the first portion, and transmits the second portion of the divided index structure to the information processing apparatus. The information processing apparatus performs the compaction on the second portion of the divided index structure, and sends back the second portion that has undergone the compaction to the storage apparatus. Then, the storage apparatus merges the first portion that has undergone the compaction in the storage apparatus and the second portion that has undergone the compaction and received from the information processing apparatus.

### CROSS-REFERENCE TO RELATED APPLICATION

This application is based upon and claims the benefit of priority of the prior Japanese Patent Application No. 2021-21785, filed on Feb. 15, 2021, the entire contents of which are incorporated herein by reference.

### FIELD

The embodiment discussed herein is related to a storage system, a storage apparatus, and a method of processing compaction.

### BACKGROUND

A storage system may be realized based on a hyper-converged Infrastructure (HCI) or a storage disaggregation architecture.

FIG. 1 illustrates an example of a storage system 900 based on the HCI in a related example.

The storage system 900 illustrated in FIG. 1 includes a plurality of (two in the illustrated example) HCI nodes 9. The HCI nodes 9 are communicably coupled to each other via a network 8. Each of the HCI nodes 9 includes a central processing unit (CPU) 61, a memory 62, and a storage 63.

In the storage system 900 illustrated in FIG. 1, a compute side and a storage side are aggregated into a physical node by a virtualization technique to realize integrated management. A scale out is performed for each of the HCI nodes 9. The scale out is not able to be performed separately on the compute side and the storage side.

FIG. 2 illustrates an example of a storage system 600 based on a storage disaggregation architecture in the related example.

The storage system 600 illustrated in FIG. 2 includes a plurality of (two in the illustrated example) compute nodes 6 (may also be referred to as “compute nodes #1, #2”) and a storage node 7. The compute nodes 6 and the storage node 7 are communicably coupled to each other via the network 8.

Each of the compute nodes 6 includes the CPU 61 and the memory 62. The storage node 7 includes a plurality of (two in the illustrated example) storages 71.

In the storage system 600 illustrated in FIG. 2, the compute side and the storage side may be independently scheduled and integrally managed. On the storage side, scheduling is performed with raw storages such as just a bunch of disks (JBOD) and a just a bunch of flash (JBOF). Thus, the cost may be reduced.

In the storage system 600 based on the storage disaggregation architecture, a compaction process for a sorted strings table (SSTable) may be carried out by using a log-structured merge tree (LSM-Tree). The LSM-Tree is an index structure used in a modern key-value store and includes a memtable and an SSTable as its structures.

The memtable is a mutable index structure on an in-memory and implemented by using a skip-list or the like. The SSTable is a hierarchical index structure. When the memtable becomes full, data in the memtable is sorted, set to immutable, and written to the SSTable in a log-structured format. When the same key is overwritten, a plurality of SSTables exist. Thus, the compaction process is periodically performed.

However, a processing load of the compaction process for the SSTable using the LSM-tree is high, and a tail latency may be worsened.

Japanese National Publication of International Patent Application Nos. 2020-514935 and 2016-519810 are disclosed as related art.

Bindschaedler, L., Goel, A., & Zwaenepoel, W. (2020, March). Hailstorm: Disaggregated Compute and Storage for Distributed LSM-based Databases. In Proceedings of the Twenty-Fifth International Conference on Architectural Support for Programming Languages and Operating Systems (pp. 301-316) is also disclosed as related art.

### SUMMARY

According to an aspect of the embodiments, a method of processing compaction in a storage system is performed by a storage apparatus and an information processing apparatus. The storage apparatus divides a sorted index structure at a predetermined position into a first and a second portion, performs the compaction on the first portion, and transmits the second portion of the divided index structure to the information processing apparatus. The information processing apparatus performs the compaction on the second portion of the divided index structure, and sends back the second portion that has undergone the compaction to the storage apparatus. Then, the storage apparatus merges the first portion that has undergone the compaction in the storage apparatus and the second portion that has undergone the compaction and received from the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a storage system based on a hyper-converged infrastructure (HCI) in a related example;

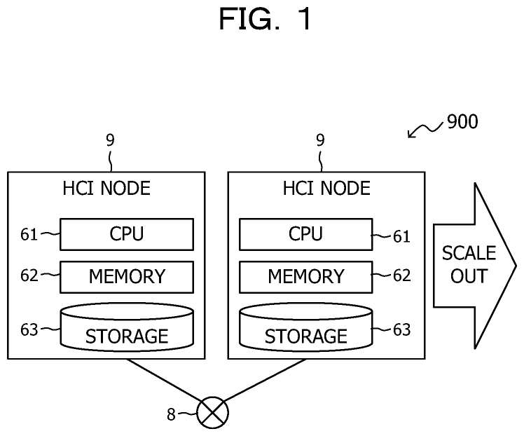

FIG. 2 illustrates an example of a storage system based on a storage disaggregation architecture in the related example;

FIG. 3 explains offloading of a compaction process in the storage system illustrated in FIG. 2;

FIG. 4 explains the compaction process in a storage system as an embodiment;

FIG. 5 explains an example of division of an SSTable in the compaction process illustrated in FIG. 4;

FIG. 6 is a timing chart of processes on a compute side and a storage side in the storage system illustrated in FIG. 4;

FIG. 7 is a block diagram schematically illustrating a hardware configuration example of the storage system illustrated in FIG. 4;

FIG. 8 is a block diagram schematically illustrating a software configuration example of a compute node illustrated in FIG. 7;

FIG. 9 is a block diagram schematically illustrating a software configuration example of a Smart-NIC in a storage node illustrated in FIG. 7;

FIG. 10 is a flowchart explaining the compaction process in the storage node as the embodiment; and

FIG. 11 is a flowchart explaining the details of an SSTable division position determination process illustrated in FIG. 10.

### DESCRIPTION OF EMBODIMENTS

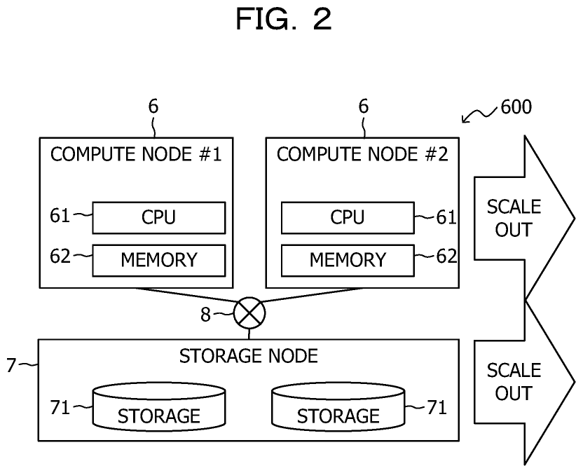

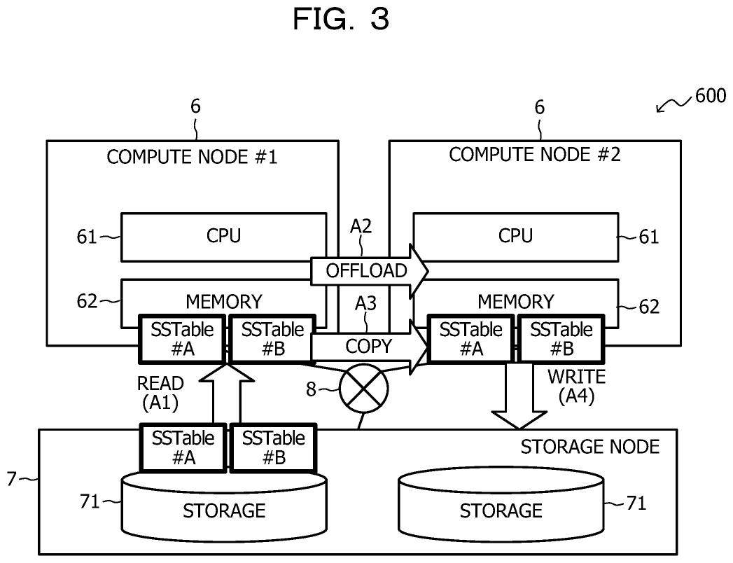

FIG. 3 explains offloading of the compaction process in the storage system 600 illustrated in FIG. 2.

As indicated by a reference sign A1, in the offloading of the compaction process, a plurality of SSTables (SSTables #A, #B in an example illustrated in FIG. 3) are read from the disk to the compute node #1. As indicated by a reference sign A2, when the compaction process for the SSTables #A, #B is offloaded to another node, the SSTables #A, #B are, as indicated by a reference sign A3, copied to the compute node #2 that is the destination of the offloading. Thus, as indicated by a reference sign A4, writing from the compute node #2 to the storage node 7 is performed. However, this may increase the amount of data transfer.

For example, transfer of the SSTable may suppress the network band and cause degradation of the performance.

In one aspect, an object is to suppress degradation of the performance of a storage system.

### [A] Embodiment

An embodiment will be described below with reference to the drawings. The embodiment described below is merely exemplary and is not intended to exclude application of various modification examples or techniques that are not explicitly described in the embodiment. For example, the present embodiment may be carried out by modifying the embodiment in various manners without departing from the gist of the embodiment. Each of the drawings is not intended to indicate that the drawn elements alone are included. Other functions or the like may be included.

The same reference signs denote the same or similar elements in the drawings, so that the description thereof is omitted below.

[A-1] Configuration Example

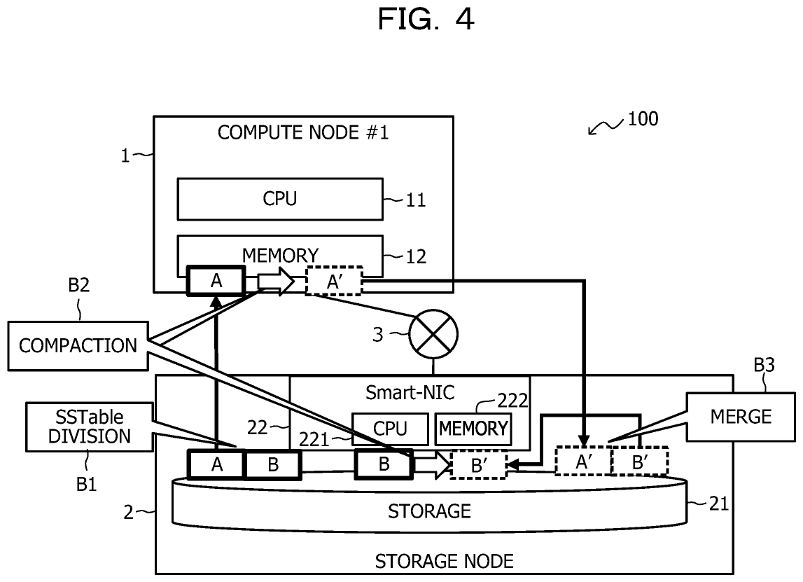

FIG. 4 explains a compaction process in a storage system 100 as the embodiment.

The storage system 100 illustrated in FIG. 4 includes a compute node 1 (may also be referred to as a “compute node #1”) and a storage node 2. The compute node 1 and the storage node 2 are communicably coupled to each other via a network 3.

The compute node 1 is an example of an information processing apparatus and includes a central processing unit (CPU) 11 and a memory 12. The storage node 2 is an example of a storage apparatus and includes a storage 21 and a smart network interface card (smart-NIC) 22. The smart-NIC 22 includes a CPU 221 and a memory 222.

As described above, a computing function is provided on the storage node 2 side with the smart-NIC 22 or the like, thereby the compaction process is shared between the compute side and the storage side.

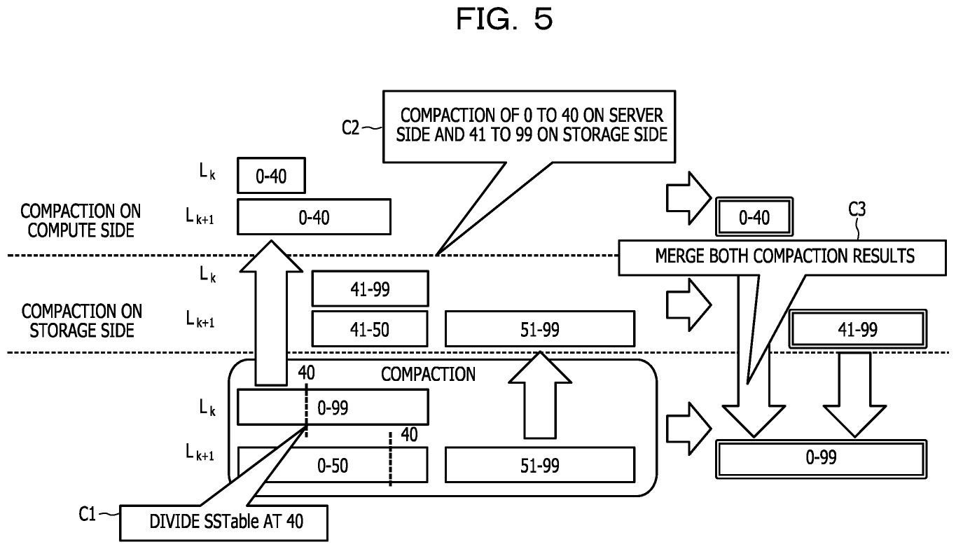

As indicated by a reference sign B1, a sorted strings table (SSTable) is divided in a specific key range (to be described later with reference to, for example, FIG. 5), and as indicated by a reference sign B2, the compaction process is carried out in parallel on the compute node 1 side and the storage node 2 side. As indicated by a reference sign B3, a result of the compaction process carried out on the compute node 1 side is moved to the storage node 2 side and merged.

In the example illustrated in FIG. 4, the SSTable is divided into “A” and “B”, “A” of the SSTable is caused to undergo compaction to become “A” in the compute node 1, and “B” is caused to undergo the compaction to become “B” in the storage node 2. In the storage node 2, “A” and “B” having undergone the compaction are merged.

FIG. 5 explains an example of the division of SSTable in the compaction process illustrated in FIG. 4.

When the compaction process is performed on a key range 0 to 99 of levels Lₖ and Lₖ₊₁, the SSTable is divided at 40 as indicated by a reference sign C1. For example, as indicated by a reference sign C2, the compaction process is performed on 0 to 40 on the compute side and 41 to 99 on the storage side. As indicated by a reference sign C3, results of the compaction process on both the compute side and the storage side are merged.

Since the compaction process itself merges a plurality of columns already sorted by keys, there is no problem even with the processing with the division in a specific key range.

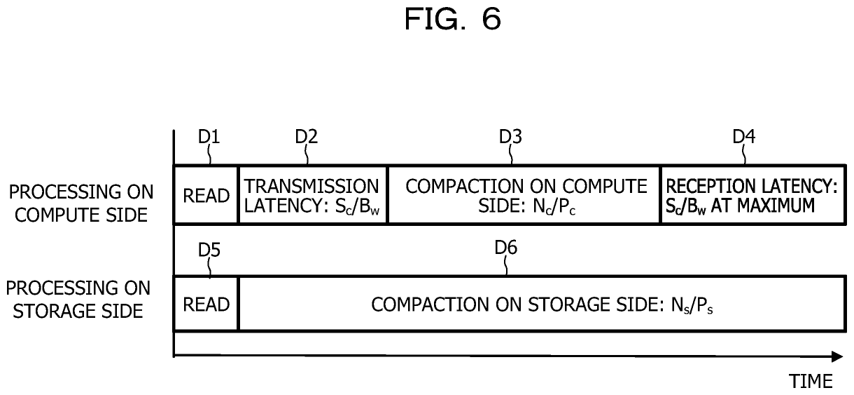

FIG. 6 is a timing chart of the processes on the compute side and the storage side in the storage system 100 illustrated in FIG. 4.

The division position of the SSTable may be determined at a position where “SSTable transmission and reception time to the compute side+compaction processing time on the compute side” and “compaction processing time on the storage side” are balanced. Since a reception latency depends on how many overlapping keys exist and is not easily estimated before the compaction process, the same value as the transmission amount may be set as the maximum value.

It is assumed that a CPU capacity on the compute side is P_{c} [req/sec], a CPU capacity on the storage side is Pₛ [req/sec], the number of keys to be processed on the compute side is N_{c}, and the number of keys to be processed on the storage side is Nₛ. It is also assumed that an SSTable size to be processed on the compute side is S_{c} [Byte], an SSTable size to be processed on the storage side is Sₛ [Byte], and a network band is B_{w} [B/s].

Since the size of the SSTable in each key is not uniform, algebraic direct solving is not easy. Thus, the balancing position may be obtained by, for example, a binary search.

In the example illustrated in FIG. 6, the total time of the processing on the compute side is represented by read (reference sign D1)+transmission latency: S_{c}/B_{w} (reference sign D2)+compute side compaction: N_{c}/P_{c} (reference sign D3)+maximum reception latency S_{c}/B_{w} (reference sign D4). The total time of the processing on the storage side is represented by read (reference sign D5)+storage side compaction: Nₛ/Pₛ (reference sign D6). The total time of the processing on the compute side and the total time at a storage processing position are determined so as to be balanced.

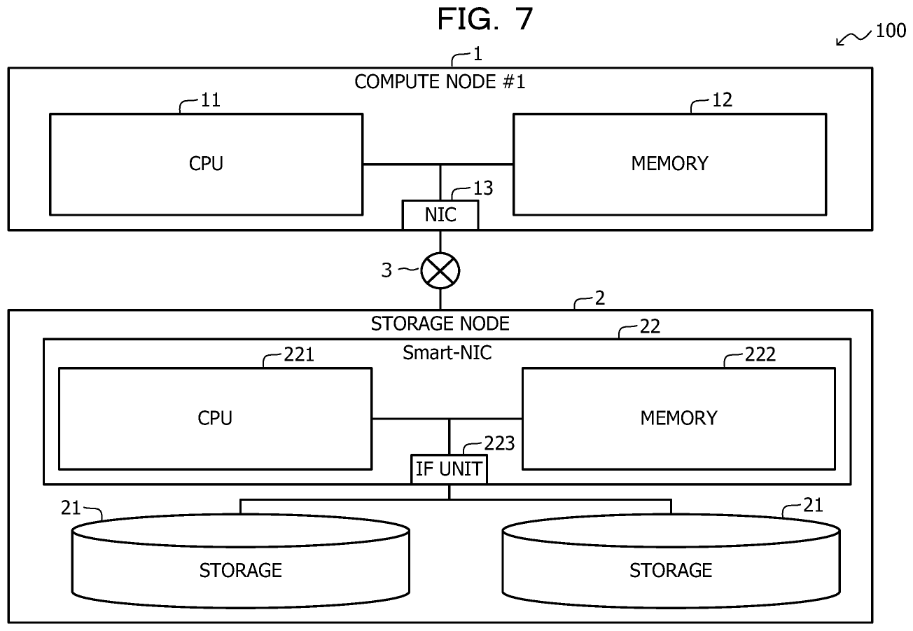

FIG. 7 is a block diagram schematically illustrating a hardware configuration example of the storage system 100 illustrated in FIG. 4.

The storage system 100 includes the compute node 1 and the storage node 2. The compute node 1 and the storage node 2 are communicably coupled to each other via the network 3.

The compute node 1 includes the CPU 11, the memory 12, and a network interface card (NIC) 13.

The NIC 13 is an adapter for coupling the compute node 1 to the network 3 and is, for example, a local area network (LAN) card.

The memory 12 is, for example, a storage device including a read-only memory (ROM) and a random-access memory (RAM). The RAM may be, for example, a dynamic RAM (DRAM). Programs such as a Basic Input/Output System (BIOS) may be written in the ROM of the memory 12. The software programs in the memory 12 may be loaded into and executed by the CPU 11 as appropriate. The RAM of the memory 12 may be used as a primary recording memory or a working memory. The memory 12 has a memtable that includes an SSTable holding area and a log-structured merge-tree (LSM-Tree) structure.

For example, the CPU 11, which is a processing device that performs various types of control and various computations, realizes various functions by executing an operating system (OS) and the programs stored in the memory 12.

The programs to realize the functions of the CPU 11 may be provided in a form in which the programs are recorded in a computer-readable recording medium such as, for example, a flexible disk, a compact disk (CD such as a CD-ROM, a CD-recordable (CD-R), or a CD-rewritable (CD-RW)), a Digital Versatile Disk (DVD such as a DVD-ROM, a DVD-RAM, a DVD-R, a DVD+R, a DVD-RW, a DVD+RW, or a high-definition (HD) DVD), a Blu-ray disk, a magnetic disk, an optical disk, or a magneto-optical disk. The computer (the CPU 11 according to the present embodiment) may read the programs from the above-described recording medium via a reading device (not illustrated), transfer and store the read programs to an internal recording device or an external recording device, and use the programs. The programs may be recorded in a storage device (recording medium) such as, for example, a magnetic disk, an optical disk, or a magneto-optical disk and provided from the storage device to the computer via a communication path.

When the functions of the CPU 11 are realized, the programs stored in the internal storage device (the memory 12 according to the present embodiment) may be executed by the computer (the CPU 11 according to the present embodiment). The computer may read and execute the programs recorded in the recording medium.

For example, the CPU 11 controls entire operations of the compute node 1. A device for controlling the entire operations of the compute node 1 is not limited to the CPU 11 but may be any one of, for example, a microprocessor unit (MPU), a digital signal processor (DSP), an application-specific integrated circuit (ASIC), a programmable logic device (PLD), and a field-programmable gate array (FPGA). The device for controlling the entire operations of the compute node 1 may be a combination of two or more of the CPU, the MPU, the DSP, the ASIC, the PLD, and the FPGA.

The storage node 2 includes a plurality of (two in the illustrated example) storages 21 and the Smart-NIC 22.

Each of the storages 21 is, for example, a device that stores data such that the data is able to read from and write to the storage 21. The storage 21 may be, for example, a hard disk drive (HDD), a solid-state drive (SSD), or a storage class memory (SCM).

The Smart-NIC 22 is an example of an arithmetic unit and includes the CPU 221, the memory 222, and an interface (IF) unit 223.

The IF unit 223 couples the Smart-NIC 22 to the storages 21 such that the storages 21 are accessible by the Smart-NIC 22.

The memory 222 is, for example, a storage device including a ROM and a RAM. The RAM may be, for example, a DRAM. The programs such as a BIOS may be written in the ROM of the memory 222. The software programs in the memory 222 may be loaded into and executed by the CPU 221 as appropriate. The RAM of the memory 222 may be used as a primary storage memory or a working memory. The memory 222 has the SSTable holding area.

For example, the CPU 221, which is a processing device that performs various types of control and various computations, realizes various functions by executing an OS and the programs stored in the memory 222.

The programs to realize the functions of the CPU 221 may be provided in a form in which the programs are recorded in a computer-readable recording medium such as, for example, a flexible disk, a CD (such a CD-ROM, a CD-R, or a CD-RW), a DVD (such as a DVD-ROM, a DVD-RAM, a DVD-R, a DVD+R, a DVD-RW, a DVD+RW, or an HD DVD), a Blu-ray disk, a magnetic disk, an optical disk, or a magneto-optical disk. The computer (the CPU 221 according to the present embodiment) may read the programs from the above-described recording medium via a reading device (not illustrated), transfer and store the read programs to an internal recording device or an external recording device, and use the programs. The programs may be recorded in a storage device (recording medium) such as, for example, a magnetic disk, an optical disk, or a magneto-optical disk and provided from the storage device to the computer via a communication path.

When the functions of the CPU 221 are realized, the programs stored in the internal storage device (the memory 222 according to the present embodiment) may be executed by the computer (the CPU 221 according to the present embodiment). The computer may read and execute the programs recorded in the recording medium.

For example, the CPU 221 controls entire operations of the storage node 2. A device for controlling the entire operations of the storage node 2 is not limited to the CPU 221 but may be any one of, for example, an MPU, a DSP, an ASIC, a PLD, and an FPGA. The device for controlling the entire operations of the storage node 2 may be a combination of two or more of the CPU, the MPU, the DSP, the ASIC, the PLD, and the FPGA.

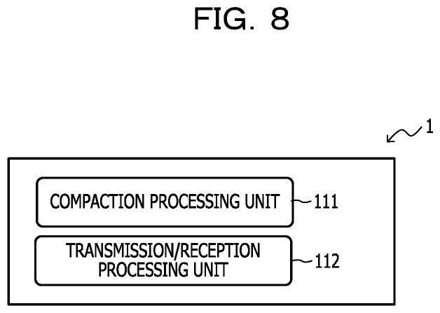

FIG. 8 is a block diagram schematically illustrating a software configuration example of the compute node 1 illustrated in FIG. 7.

The CPU 11 of the compute node 1 illustrated in FIG. 7 functions as a compaction processing unit 111 and a transmission/reception processing unit 112 as illustrated in FIG. 8.

As indicated by the reference sign B2 illustrated in FIG. 4, the compaction processing unit 111 executes the compaction process for a portion of the divided SSTable. For example, the compaction processing unit 111 functions as an example of a second compaction processing unit that performs the compaction on a second portion of an index structure divided by the storage node 2.

The transmission/reception processing unit 112 executes a GET process that receives from the storage node 2 the portion of the divided SSTable and a PUT process that transmits to the storage node 2 the portion of the SSTable having undergone the compaction process.

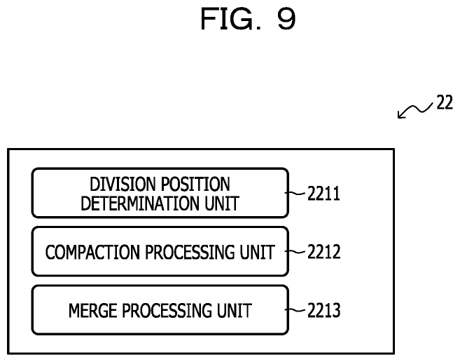

FIG. 9 is a block diagram schematically illustrating a software configuration example of the Smart-NIC 22 in the storage node 2 illustrated in FIG. 7.

The CPU 221 of the Smart-NIC 22 illustrated in FIG. 7 functions as a division position determination unit 2211, a compaction processing unit 2212, and a merge processing unit 2213 as illustrated in FIG. 9.

As indicated by the reference sign B1 illustrated in FIG. 4, the division position determination unit 2211 determines the division position of the SSTable and transmits the portion of the divided SSTable to the compute node 1. For example, the division position determination unit 2211 functions as an example of a division processing unit that divides the sorted index structure at a predetermined position when the compaction process for the index structure in a storage disaggregation architecture is offloaded. The division position determination unit 2211 may determine the predetermined position by using a binary search. The division position determination unit 2211 may determine the predetermined position such that the compaction processing time in the storage node 2 agrees with the sum of double the transmission latency and the compaction processing time in the compute node 1.

As indicated by the reference sign B2 illustrated in FIG. 4, the compaction processing unit 2212 executes the compaction process for the portion of the divided SSTable. For example, the compaction processing unit 2212 functions as an example of a first compaction processing unit that performs the compaction on a first portion of the divided index structure and causes the compute node 1 to cause the compute node 1 to performs the compaction on the second portion of the divided index structure.

The merge processing unit 2213 receives from the storage node 2 the portion of the SSTable having undergone the compaction process. As indicated by the reference sign B3 illustrated in FIG. 4, the merge processing unit 2213 merges the portion of the SSTable having undergone the compaction process in the storage node 2 and the portion of the SSTable having undergone the compaction process in the compute node 1. For example, the merge processing unit 2213 merges the first portion having undergone the compaction performed by the storage node 2 and the second portion having undergone the compaction performed by the compute node 1.

[A-2] Example of Operation

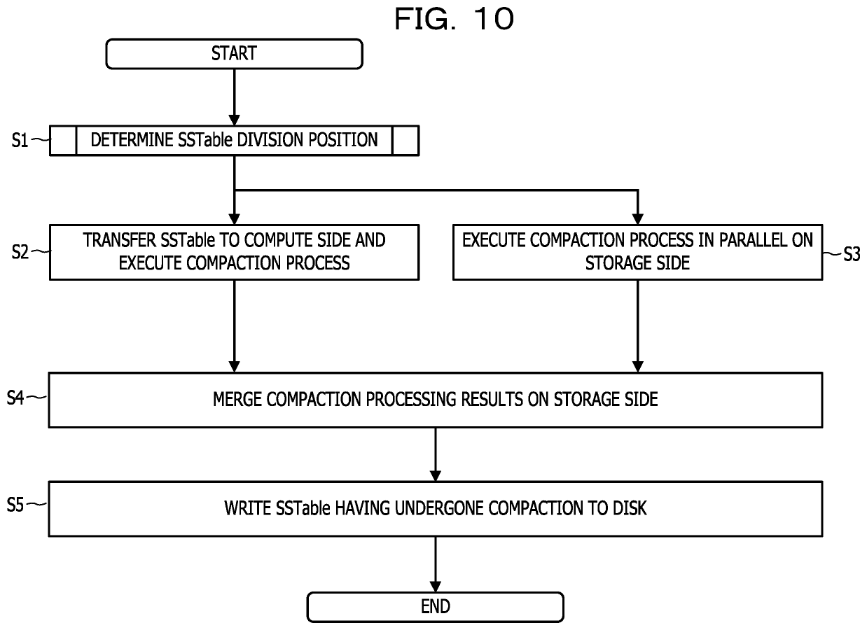

The compaction process in the storage node 2 as the embodiment will be described with reference to a flowchart (steps S1 to S5) illustrated in FIG. 10.

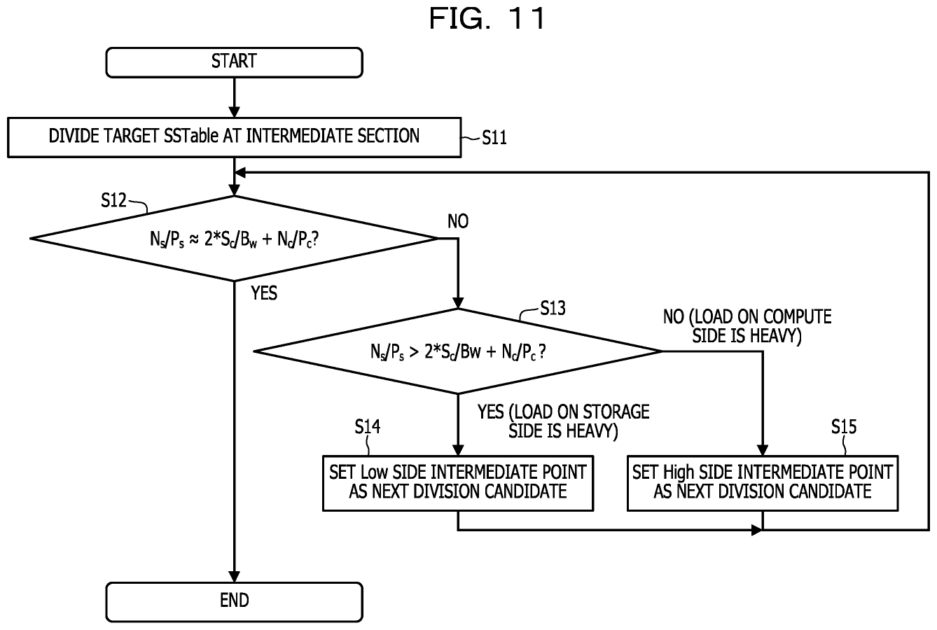

The division position determination unit 2211 determines the division positions of the SSTable (step S1). The details of the division position determination process in step S1 will be described later with reference to a flowchart illustrated in FIG. 11.

The compaction processing unit 2212 transfers the SSTable to the compute side to cause the compute side to execute the compaction process (step S2) and executes the compaction process on the storage side concurrently with the compaction process on the compute side (step S3).

The merge processing unit 2213 merges, on the storage side, the results of the compaction process (step S4).

The merge processing unit 2213 writes the SSTable having undergone the compaction process to a disk of the storage 21 (step S5). Then, the compaction process ends.

Next, the details of the SSTable division position determination process illustrated in FIG. 10 will be described with reference to the flowchart (steps S11 to S15) illustrated in FIG. 11.

The division position determination unit 2211 divides the target SSTable at an intermediate section (step S11).

The division position determination unit 2211 determines whether the compaction processing time Nₛ/Pₛ on the storage side substantially agrees with the sum of double the transmission latency S_{c}/B_{w} and the compaction processing time N_{c}/P_{c} on the compute side (for example, whether Nₛ/Pₛ≈2*S_{c}/B_{w}+N_{c}/P_{c} holds) (step S12). Since the reception latency on the compute side at the maximum is S_{c}/B_{w} equal to the transmission latency, double the transmission latency S_{c}/B_{w} is added. The determination of the substantial agreement may be made based on whether the calculation results are within a range of a predetermined margin.

When Nₛ/Pₛ≈2*S_{c}/B_{w}+N_{c}/P_{c} holds (see a YES route in step S12), the division position determination unit 2211 determines the division position and ends the division position determination process.

In contrast, when Nₛ/Pₛ≈2*S_{c}/B_{w}+N_{c}/P_{c} does not hold (see a NO route in step S12), the division position determination unit 2211 determines whether the compaction processing time Nₛ/Pₛ on the storage side is greater than the sum of double the transmission latency S_{c}/B_{w} and the compaction processing time N_{c}/P_{c} on the compute side (for example, whether Nₛ/Pₛ>2*S_{c}/B_{w}+N_{c}/P_{c} holds) (step S13).

When Nₛ/Pₛ>2*S_{c}/B_{w}+N_{c}/P_{c} holds (for example, a load on the storage side is heavy) (see a YES route in step S13), an intermediate point on a Low side is set as a next division candidate (step S14), and processing returns to step S12.

In contrast, when Nₛ/Pₛ≤2*S_{c}/B_{w}+N_{c}/P_{c} holds (for example, a load on the compute side is heavy) (see a NO route in step S13), an intermediate point on a High side is set as the next division candidate (step S15), and the processing returns to step S12.

[A-3] Effects

With the storage system, the storage apparatus, and a method of processing compaction according to the above-described embodiment, for example, the following operation effects may be obtained.

The division position determination unit 2211 divides the sorted index structure at a predetermined position when the compaction process for the index structure in the storage disaggregation architecture is offloaded. The compaction processing unit 2212 performs the compaction on the first portion of the divided index structure and causes the compute node 1 to perform the compaction on the second portion of the divided index structure. The merge processing unit 2213 merges the first portion having undergone the compaction performed by the storage node 2 and the second portion having undergone the compaction performed by the compute node 1.

Thus, degradation of the performance of the storage system 100 may be suppressed. For example, since the SSTable moved to the compute side is only part of the whole, the network band may be saved. Since the storage side and the compute side cooperate with each other to perform the compaction process, which is likely to become a bottleneck, an increase in the processing speed may be expected, and degradation in the tail latency may be suppressed.

The division position determination unit 2211 determines the predetermined position by using a binary search. Thus, the division position may be efficiently determined.

The division position determination unit 2211 determines the predetermined position such that the compaction processing time in the storage node 2 agrees with the sum of double the transmission latency and the compaction processing time in the compute node 1. Thus, degradation of the performance of the storage system 100 may be further suppressed.

### [B] Others

The disclosed technique is not limited to the above-described embodiment. The disclosed technique may be carried out by variously modifying the technique without departing from the gist of the present embodiment. Each of the configurations and each of the processes of the present embodiment may be selectively employed or omitted as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage system comprising a storage apparatus and an information processing apparatus, wherein
the storage apparatus is configured to:
divide a sorted index structure at a predetermined position when a compaction process for the index structure in a storage disaggregation architecture is offloaded;
perform the compaction on a first portion of the divided index structure; and
transmit a second portion of the divided index structure to the information processing apparatus;
the information processing apparatus is configured to:
perform the compaction on the second portion of the divided index structure received from the storage apparatus; and
transmit the second portion that has undergone the compaction to the storage apparatus; and
the storage apparatus is further configured to:
merge the first portion that has undergone the compaction in the storage apparatus and the second portion that has undergone the compaction by the information processing apparatus and is received from the information processing apparatus.

2. The storage system according to claim 1, wherein
the predetermined position is determined by using a binary search.

3. The storage system according to claim 1, wherein
the predetermined position is determined so as to make an amount of compaction processing time in the storage apparatus in agreement with a sum of double a transmission latency from the storage apparatus to the information processing apparatus and an amount of compaction processing time in the information processing apparatus.

4. A storage apparatus comprising:
a memory,
a storage, and
a processor coupled to the memory and the storage, and configured to:
divide a sorted index structure at a predetermined position when a compaction process for the index structure in a storage disaggregation architecture is offloaded;
perform the compaction on a first portion of the divided index structure;
transmit a second portion of the divided index structure to an information processing apparatus that performs the compaction on the second portion of the divided index structure;
receive the second portion that has undergone the compaction from the information processing apparatus; and
merge the first portion that has undergone the compaction in the storage apparatus and the second portion that has undergone the compaction by the information processing apparatus and is received from the information processing apparatus.

5. The storage apparatus according to claim 4, wherein
the predetermined position is determined by using a binary search.

6. The storage apparatus according to claim 4, wherein
the predetermined position is determined so as to make an amount of compaction processing time in the storage apparatus in agreement with a sum of double a transmission latency from the storage apparatus to the information processing apparatus and an amount of compaction processing time in the information processing apparatus.

7. A method of processing compaction in a storage system that includes a storage apparatus and an information processing apparatus, the method comprising:
dividing, in the storage apparatus, a sorted index structure at a predetermined position when a compaction process for the index structure in a storage disaggregation architecture is offloaded;
performing, in the storage apparatus, the compaction on a first portion of the divided index structure;
transmitting a second portion of the divided index structure from the storage apparatus to the information processing apparatus;
performing, in the information processing apparatus, the compaction on the second portion of the divided index structure received from the storage apparatus;
transmitting the second portion that has undergone the compaction from the information processing apparatus to the storage apparatus; and
merging, in the storage apparatus, the first portion that has undergone the compaction in the storage apparatus and the second portion that has undergone the compaction and is received from the information processing apparatus.

8. The method according to claim 7, wherein
the predetermined position is determined, in the storage apparatus, by using a binary search.

9. The method according to claim 7, wherein
the predetermined position is determined, in the storage apparatus, so as to make an amount of compaction processing time in the storage apparatus in agreement with a sum of double a transmission latency from the storage apparatus to the information processing apparatus and an amount of compaction processing time in the information processing apparatus.
